(19) United States
(12) Patent Application Publication
(10) Pub. No.: US 2026/0146745 A1
(43) Pub. Date: May 28, 2026

(54) INFRARED HEATING SYSTEM

(71) Applicant: Herschel Infrared Ltd, Avonmouth (GB)

(72) Inventors: Richard MARTIN, Avonmouth (GB); Paul MOREY, Avonmouth (GB)

(21) Appl. No.: 18/963,000

(22) Filed: Nov. 27, 2024

(51) Int. Cl. F24D 19/10; F24D 5/06; G05D 23/19

(52) U.S. Cl. CPC F24D 19/1084; F24D 5/06; G05D 23/1928

(57) ABSTRACT

An infrared heating system comprising: an infrared heater, a temperature sensor unit comprising a radiant heat sensor and an air temperature sensor; a controller arranged to: receive a target temperature; receive temperature sensor data from the temperature sensor unit; and provide an output signal to the heater based on the temperature sensor data and the target temperature.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Infrared heating systems can include a temperature sensor to monitor the temperature of a space in order to determine when to switch on and thus provide heat and when to switch off. However, currently infrared heating systems rely on thermostats which have disadvantages. For example, an ambient air temperature sensor can be slow to react to an increase in infrared radiation within a space. An infrared radiation sensor may not provide a reliable reading for interpreting human comfort.

There is therefore a need for an improved infrared heating system which can reliably monitor the temperature of a space and provide an optimised heating response and/or optimise energy consumption.

### SUMMARY

According to a first aspect of the invention, there is provided an infrared heating system comprising: an infrared heater; a temperature sensor unit comprising a radiant heat sensor and an air temperature sensor; and a controller arranged to: receive a target temperature; receive temperature sensor data from the temperature sensor unit; and provide an output signal to the heater based on the temperature sensor data and the target temperature.

The temperature sensor data may include a temperature measurement value. The temperature measurement value can be provided by the radiant heat sensor and air temperature sensor together, or either one individually.

This is advantageous as it provides a sensor which can more accurately determine the temperature representative of human comfort (i.e. the average of air and radiant temperatures). Radiant heat sensors do not provide an accurate measurement of the temperature of the ambient air because they are embedded in a material (which may be a polycarbonate) to sense how that material heats up and don't have direct access to environmental air to be able to sense its temperature. This is especially apparent when an infrared heater is warming up and cooling down. An infrared heat sensor is responsive to the temperature change of objects however, monitoring the radiant heat of an object may lead to an underestimate of the wider air temperature. Measuring air temperature alone can misrepresent the mean radiant temperature, which is a key component of comfort. So the temperature sensor should be able to sense both air and radiant temperatures in combination and individually.

Therefore, the temperature sensor according to the first aspect of the invention can be used in a system with an infrared heater to provide a more accurate heat to the space which is desired to be heated. In turn, this provides a system which can reduce energy consumption and/or more efficiently provide heat to a space.

A combined air temperature and radiant heat sensor provides advantages which relate to energy use and human comfort. Existing infrared panel heaters are run sub-optimally due to the reliance on a single type of temperature measurement (i.e., according to air temperature alone, or radiant heat sensor alone). Moreover, the present system is advantageous over conventional heaters as conventional heaters have a lower radiant effectiveness than infrared heaters meaning that conventional heaters consume more energy than is necessary in over-heating the air, they are insufficiently radiant to make a measurable and controllable radiant heat response in the environment and so cannot be perfectly optimized for human comfort.

The infrared heater may be configured to operate in at least two heating modes, wherein the first heating mode is a full power mode, and the second heating mode is a partial heating mode such that the infrared output over a time period is lower in the second heating mode than the first heating mode.

This is advantageous as it may provide multiple heating levels to provide precise control over the infrared heating provided to the space being heated. The first heating mode may comprise powering the infrared heater such that infrared heat is emitted from a greater surface area than that of the second heating mode. Alternatively, the difference in the infrared output over a time period could be based on the length of time a portion of the infrared heating panel is activated for.

The temperature sensor data may comprise data based on an average of the temperature sensor data from the radiant heat sensor and the air temperature sensor when operating in the first heating mode.

The temperature sensor data may comprise data from the radiant heat sensor or the air temperature sensor (whichever provides the quickest response) when operating in the second heating mode.

This is advantageous as during the first heating mode (which may be a full power mode), the temperature measurement is based on a widespread temperature of the space being monitored. By using both air temperature data and radiant heat data, the impact of the slow response time of either the air temperature or the radiant temperature data can be minimised whilst still utilising the advantage of monitoring the average of both temperatures temperature within a space. During the second heating mode (which may be a partial heating mode), the temperature data may be required to be more reactive and therefore it is advantageous to provide data based on a second, more sensitive reading, whether this is due to an air temperature fluctuation on its own, or a radiant fluctuation on its own (as either may happen first depending on the environment)

The temperature sensor data may consist of interpreting the reading of both the air temperature sensor and the radiant heat sensor when operating in the second heating mode and determining which one is moving the most and reacting to it.

This is advantageous as in many situations, either air temperature can move quicker than radiant (i.e. a draughty house with reflective or poorly absorbent surfaces) or radiant temperature can move faster than air (i.e. a well-insulated house with highly absorbent surfaces). Therefore, by basing a temperature reading on whichever of the two is moving the quickest, the temperature senor unit can reliably provide a quick temperature reading and apply finer temperature changes through the heater.

The temperature sensor data may be a temperature value determined by averaging a radiant heat sensor measurement and an air temperature sensor measurement or one or the other.

This is advantageous as it provides a temperature value which is calculated with an equal weighting given to the two forms of temperature reading as well as understanding the separate temperature values as well.

The controller can be configured to switch the heater between the first and second heating modes based on a comparison between the operative temperature sensor data and a threshold temperature.

The controller can comprise a receiver arranged in wired connection with the heating panel and a data processor arranged in wired or wireless communication with the receiver.

The infrared heating system may further comprise a user input module configured to enable a user to provide the target temperature and/or selecting a heating mode.

This is advantageous as it provides a simple interface for a user such that a temperature can be provided to the system and the system adjusts the heating modes to comfortably and efficiently achieve the chosen temperature. Alternatively, it provides a means to select an operation mode.

The receiver unit may comprise the user input module or can be arranged to wirelessly communicate with a device which comprises the user input module.

This is advantageous as it provides various means for the user to operate the infrared panel.

The temperature sensor unit may comprise a black bulb thermostat.

This is advantageous as a black bulb thermostat provides reliable temperature data resulting from infrared heat.

The infrared heater can have an operating temperature of between 40-200° C. and demonstrate a temperature rise from cold of at least 75° C., so as to be radiant in nature.

By demonstrating at least a 75° C. temperature rise from cold, an infrared heater will efficiently emit infrared radiation; for example, at a wavelength of 5-12 μm.

The infrared heater, the temperature sensor unit, the receiver unit may be arranged to be co-located in an enclosed space.

The data processor of the controller can comprise a logical application based on a server coupled to the heater and temperature sensor unit via the internet, or a physical programmable logic control collocated in the enclosed space with the heater and temperature sensor unit. The controller can be a distributed system, with one or more functional elements which are local to the heater and temperature control unit and one or more functional elements which are coupled to the heater and temperature control unit via a wired or wireless connection.

According to a second aspect of the invention, there is provided an enclosed space comprising the system according to the first aspect, wherein the temperature sensor unit is configured to maintain a direct line of sight to the infrared heater.

This provides the radiant heat sensor with optimum conditions to determine the appropriate temperature. For example, it provides a means for the temperature sensor to provide a temperature value representative of the space to be heated.

According to a third aspect of the invention, there is provided a method for controlling an infrared heater comprising: receiving a target temperature, receiving a threshold temperature, detecting a temperature, operating the infrared heater in a first heating mode when the detected temperature is lower than the threshold temperature and lower than the target temperature, and operating the infrared heater in a second heating mode when the detected temperature is lower than the target temperature and greater than the threshold temperature, wherein detecting the temperature comprises receiving temperature sensor data from a radiant heat sensor and an air temperature sensor.

This method is advantageous as it provides a variation in heating settings of an infrared heating panel in line with reliable temperature data which is compared to a desired temperature. This provides a means for coarse and fine settings of the infrared heating system.

The first heating mode may be a full power mode and the second heating mode may be a partial heating mode such that the infrared emission over a time period may be lower in the second heating mode than the first heating mode.

This is advantageous as it may provide multiple heating levels to provide further control over the infrared heating provided to the space being heated. The first heating mode may comprise powering the infrared heater such that infrared heat is emitted from a greater surface area than that of the second heating mode. Alternatively, the difference in the infrared output over a time period could be based on the length of time a portion of the infrared heating panel is activated for. For example, the first heating mode may comprise powering the infrared heater consistently and the second heating mode may comprise powering the infrared heater intermittently so that the average intensity of infrared radiation emitted is lower in the second heating mode than in the first heating mode.

Therefore, the infrared heating panel can be controlled such that the infrared heat emitted is related to the temperature at which the space to be heated is at. By providing a first heating mode which outputs a greater amount of infrared heat than a second heating mode, the infrared heater can provide full power when the space is at a temperature much lower than a target temperature and then can provide a lower power mode when the space is closer to a target temperature. This can help account for any latency between the space reaching the target temperature and the temperature sensor unit detecting that the target temperature has been reached. Latency in the system is undesirable because it can result in a space being overheated due the system not reacting fast enough when providing a signal to reduce the infrared emission when the target temperature has been met.

Detecting the temperature during the first heating mode may comprise averaging a temperature measurement taken by the radiant heat sensor and a temperature measurement taken by the air temperature sensor, and wherein detecting a temperature during the second heating mode may consist of detecting a temperature value using the radiant heat sensor or air temperature sensor, whichever one reacts the fastest.

This arrangement of temperature sensors is advantageous as it provides an accurate means for determining the temperature of the space during the different stages of heating (i.e., in the different heating modes). The average of air and radiant temperatures is called the “operative” temperature and in an enclosed space it is deemed to be the optimum ratio for human comfort.

The target temperature and/or the threshold temperature may be input via a user device wirelessly connected to the infrared heater.

This is advantageous as it provides an interface for the user to operate and control the method.

The target temperature may be between 5° C. and 45° C., preferably between 15° C. and 25° C. The threshold temperature may be 1° C. lower than the target temperature. Alternatively, the threshold temperature may be 2° C., 1.5° C., 0.5° C. lower than the target temperature.

The output signal provides the signal to the controller which controls the emission of infrared radiation from the infrared heating panel. For example, the output signal may provide a signal to power the infrared heater fully, partially, and/or remove power to the heater. Therefore, the output signal controls the intensity of infrared radiation emitted by the infrared heater.

### BRIEF DESCRIPTION OF THE DRAWINGS

Embodiments of the invention will now be described, strictly by way of example only, with reference to the accompanying drawings, of which:

FIG. 1 is a diagram of the system according to an embodiment of the invention;

FIG. 2 is a diagram of a hybrid temperature sensor suitable for use in the system;

FIG. 3 is a diagram of a receiver unit suitable for use in the system;

FIGS. 4A and 4B are diagrams of example infrared heaters suitable for use in the system;

FIG. 5 is a graphical representation of an algorithm for use in the system; and

FIG. 6 is an exemplary method of operation of the system.

### DETAILED DESCRIPTION

By way of a non-limiting overview, embodiments of the invention relate to an infrared heating system which is controlled by a sensor capable of measuring both radian heat and air temperature.

It is an established principle of human comfort that the optimum comfort temperature is the average of air temperature and mean radiant (i.e. background environment) temperature and not just air temperature and not just radiant temperature. The average of air temperature and MRT is referred to as “operative temperature”.

It is a feature of infrared heaters (as defined by IEC60675) that the majority of the heat is outputted as heat radiation which warms people and thermal mass within the range of the heater (typically 3-4 metres). A greater amount of radiant heat is absorbed the closer you are to the infrared heater. The heat from an infrared heater will mostly heat the thermal mass of the room, which in turn releases heat back into the room to gradually heat the air mass of the room. Only around 30% of the heat from the infrared heater will directly heat the air.

There exists temperature sensors for measuring air temperature (called dry bulb sensors) and sensors for measuring the amount of radiant heat received (called black bulb sensors). Black bulb sensors will measure the radiant heat from a heat source which can be, in this case an infrared heater or the mean radiant temperature (MRT) of the environment itself.

Black bulb sensors are rarely used for measurement of temperatures in domestic dwellings and smaller rooms but are used to measure the radiant or mean-radiant temperature in larger commercial areas such as sports halls if a radiant (infrared) system is the primary heating method.

For smaller rooms, whilst the operative temperature is the most appropriate measurement of thermal comfort, most temperature readings are taken by air (dry bulb) thermostats.

It is a proven feature of infrared heating panels that a good level of thermal comfort can be achieved by receiving the infrared radiation from the heater but at a lower air temperature than a room would normally have to be heated to from convection heating alone. Typically this as much as 2c.

It is also a feature of an infrared heater that a warm “zone” can be created within a larger room, such that thermal comfort of the occupant can be achieved without having to heat the thermal mass or air of the entire room. However, this thermal comfort falls away quickly once the heat source from the infrared heater is switched off.

It is equally the case that the combination of increased air temperature and the radiant heat source from the infrared heater can cause an occupant to become too hot over time. Achieving optimal thermal comfort then is dependent upon many factors and varies person to person.

Infrared heater manufacturers historically and currently recommend or supply air thermostats for measurement of temperature. Whilst this gives some measurement of thermal comfort, this is a sub optimal solution since the thermostat is not measuring the radiant temperature, or the operative temperature.

There is therefore a need for an improved infrared heating system which can reliably monitor and manage both the radiant and air temperature of a space and provide an optimised level of thermal comfort by measuring both radiant heat and air temperature and controlling the heater accordingly. There are two aspects to this. Firstly, when used as a proximity radiant heater (i.e., directly heating occupants within a “zone” in a room), locating a combined black bulb and air temperature sensor within the zone will facilitate more optimal thermal comfort readings as the black bulb sensor will be a more accurate measure of thermal comfort than the air temperature sensor. This sensor can also be used to regulate the output from the heater when combined with a variable output infrared heater. Secondly, if the heating system is used to heat an entire room, the sensor will be able to measure the both the air and radiant or MRT of the room and regulate the heater more accurately than the use of air thermostats alone. Both methods have the potential to save energy and improve thermal comfort levels.

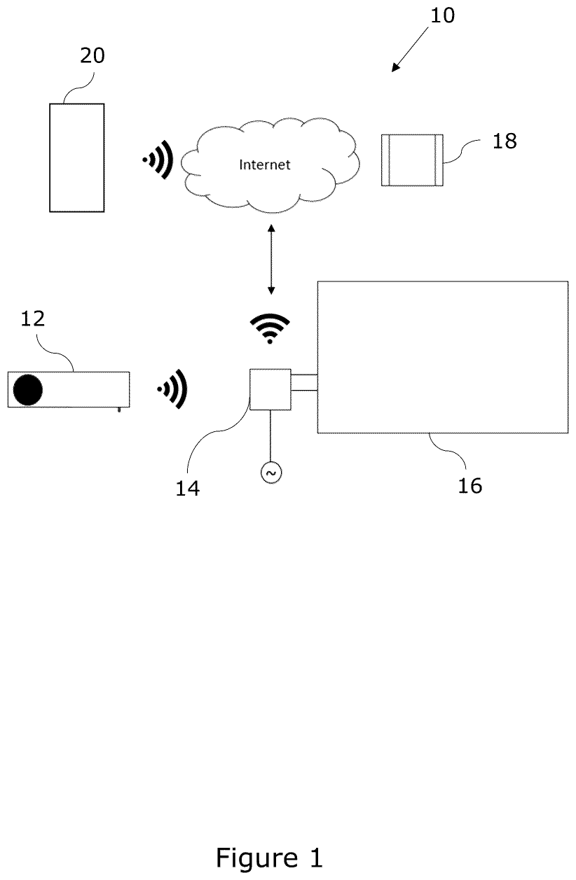

FIG. 1 shows components of an exemplary arrangement of an infrared heating system 10. The system comprises an infrared heating panel 16 coupled to a controller 14, 18 for controlling operation of the heating panel 16.

In this embodiment, the controller is distributed in nature, comprising a receiver 14 and a data processor 18.

The infrared heating panel 16 is arranged to emit infrared radiation from at least one surface, for example a front facing surface. The infrared panel 16 may be free standing or may include a mount so that the panel 16 can be secured to a surface such as a wall or ceiling. The panel 16 is arranged to emit infrared radiation from one of its major surfaces, for example a front facing surface. The infrared heating system 10 may comprise further infrared heating panels such that the system 10 includes a plurality of infrared heating panels collectively controlled.

The infrared heating panel 16 may include an infrared emission surface, a rear surface, and at least one heating element. The infrared heating panel 16 may have a rectangular horizontal cross section. The components of the heating panel may be aligned so that each layer has substantially the same footprint and external perimeter.

The infrared panel 16 may have multiple heating modes. During a first heating mode the infrared panel 16 may be operated at full power such that the intensity of infrared emission provided by the panel 16 is at a maximum. During a second heating mode the infrared panel 16 may be operated at a level lower than full power such that the intensity of infrared emission provided by the panel 16 is lower than a maximum. The multiple heating modes can be provided by various arrangements. For example, the infrared heating panel 16 may comprise a plurality of heating elements configured to operate in isolation and together. The infrared heating panel 16 may be configured to be powered by a conventional mains electric circuit.

The receiver 14 is coupled to the infrared panel 16 via a wired connection. Therefore, in some examples, the receiver 14 can be integrally formed as part of the infrared heating panel 16. The receiver 14 receives signals which determine the operation of the infrared heating panel 16. The received signals include temperature data such as a target temperature, threshold temperature, and/or current temperature within a space. The received signals further include operation signals for selecting a heating mode for the infrared heating panel 16.

The infrared heating system 10 further comprises a temperature sensing unit 12, comprising a plurality of temperature sensors. The temperature sensors within the temperature sensing unit 12 include an air temperature sensor and a radiant heat temperature sensor. The temperature sensing unit 12 may continuously monitor the temperature within a space which is arranged to be temperature controlled by the infrared heating system 10. The temperature sensing unit 12 provides temperature data to the receiver 14. The temperature data may include a temperature value determined by taking an average of the plurality of temperature sensors and/or a temperature value determined from a measurement taken by a single temperature sensor.

The data processor 18 can be located locally or remotely with respect to the infrared heating panel 16 and/or receiver 14. FIG. 1 discloses an example in which the data processor 18 is remotely coupled to the receiver 14 via an internet connection, such as a WiFi or cellular network connection. Alternatively, the data processor 18 can be located locally to the receiver 14 and/or infrared heating panel 16, in some embodiments being unified with the receiver 14. The data processor 18 provides the output signal to the receiver 14 via a wireless or wired connection to enable control of the operation of the infrared heating panel 16. The data processor 18 may form part of a user device 20 which provides an interface in which parameters for the infrared heating system 10 can be set and/or controlled.

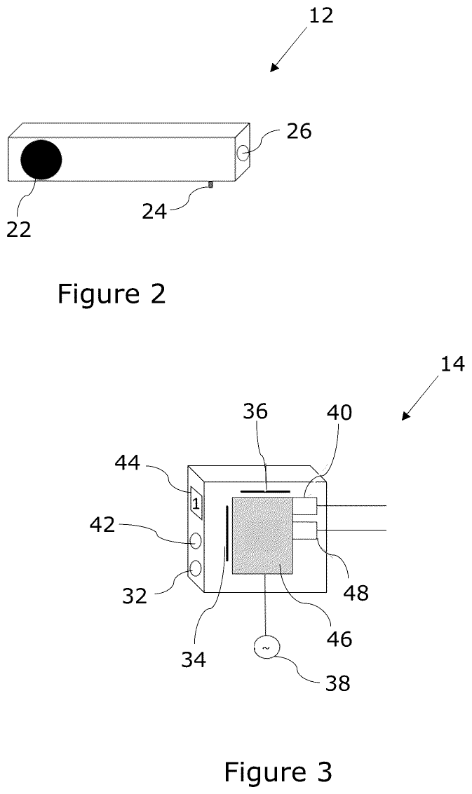

FIG. 2 shows an exemplary temperature sensor unit 12 for use in the infrared heating system 10. The temperature sensor unit comprises a radiant heat sensor 22 and an air temperature sensor 24. The radiant heat sensor 22 may be a black bulb temperature sensor. The radiant heat sensor 22 can determine the local mean radiant temperature by measuring how the radiant heat sensor 22 itself is heating up. The radiant heat sensor 22 may be arranged with a direct line of sight to the infrared heating panel 16 so that the radiant heat sensor 22 can determine the radiant effect of the panel on the local environment 16. The air temperature sensor 24 may determine the temperature at which air within the space around the temperature sensor unit 12 is at. Therefore, the air temperature sensor 24 provides a means to monitor the general air temperature of the space which is being temperature controlled by the infrared heating system 10.

The temperature sensor unit 12 may be a single unit which houses the radiant heat sensor 22 and the air temperature sensor 24. The temperature sensor unit 12 is arranged to be battery operated but can for example be powered by mains AC power. Therefore, the temperature sensor unit 12 may be arranged anywhere within the space to be temperature controlled that is within the communication range of the infrared heater 16 and/or receiver 14 and provides a direct line of sight to the infrared heating panel 16. For example, the temperature sensor unit 12 may be located up to 3 meters from the infrared panel heater 16 in which no other objects obstruct the view between the radiant heat sensor 22 and the infrared heating panel 16.

The temperature sensor unit 12 may further comprise a means to pair the unit 12 to an infrared heating panel 16. For example, a pairing switch or button 26 can be provided on the temperature sensor unit 12 which enables the unit 12 to communicate to the infrared panel 16 via the receiver 14. A single temperature sensor unit 12 may be paired to one or more infrared heating panels 16.

FIG. 3 shows an exemplary receiver 14 for use in the infrared heating system 10. The receiver unit 14 is coupled to the infrared heating panel 16 via a wired connection. The receiver unit 14 may for example be physically connected to a face of the infrared heating panel 16, such as the rear face when mounted on a surface. The receiver 14 can act as a router between the temperature sensor unit 12, the data processor 18, and the heater 16.

The receiver 14 may include a means for pairing the receiver 14 to the temperature sensor unit 12. For example, a pairing switch or button 32 can be provided on the receiver 14 which enables the infrared heater 16 to communicate with the temperature sensor unit 12 via the receiver 14. The receiver 14 may communicate using radio frequency, RF, (e.g., 433 MHz) with the sensor via an RF aerial 34. The use of RF to communicate with the temperature sensor unit 12 eliminates the need for electrical mains supply to the sensor unit 12, as RF has lower power requirements compared to WiFi systems. Therefore, a battery or mains powered sensor can be used and thus placed in the most optimal location.

The receiver 14 receives the temperature values measured by the temperature sensors 22, 24 and transmits the values to the data processor 18 via a further aerial 36. The data processor 18 may form part of an application on a user device 20. The data processor 18 provides operational commands to the heater 16 based on the temperature data received. The operational commands are in the form of an output signal from the data processor 18 to the receiver 14, which is coupled to the infrared heating panel 16. As the location of the data processor 18 is not dependent on a direct line of sight to the infrared heating panel, the controller can be located in a wider variety of regions compared to the temperature sensor unit 12. Therefore, the data processor 18 may communicate with the receiver 14 via an internet connection (e.g., 2.4 GHZ) as the receiver 14 may be powered via a mains connection 38.

The receiver 14 has at least one connection to the infrared heating panel 16. The connection between the receiver 14 and the infrared heating panel 16 provides a means to communicate the operation signals from the data processor 18 to the infrared heating panel 16. In an example, such as the one disclosed by FIG. 3, the receiver may have two connections 40, 48 to the infrared heating panel 16. The first connection 40 may be used for control of at least a portion of the infrared heating panel 16. For example, if the infrared heating panel 16 comprises a single heating element, the first connector 40 may be arranged to provide a signal to power the heating element. Alternatively, if the infrared heating panel 16 comprises a plurality of independent heating elements, the first connector 40 may be used to provide a signal to power one and/or a plurality of the heating elements. A second connector 48 may be used for control of at least a further portion of the infrared heating panel 16. For example, the second connector 48 may be arranged to provide a signal to power one of the plurality of heating elements.

The receiver 14 may further comprise a means to manually select a heating operation of the infrared heating panel 16. For example, a push-button or switch 42 may be located on the receiver which allows the selection of options such as “OFF, 1, 2,3” which may represent the 3 manual power settings (Off, Level 1, Level 2, Full Power). A display 44 may be provided such that the heating operation selected can be seen by a user. For example, the receiver 14 may include an LED display 44.

The receiver may further comprise a means to enable function and connectivity such as a printed circuit board (PCB) 46. The PCB 46 may comprise a processor, hardware for the WiFi and RF connectivity, and capacitors.

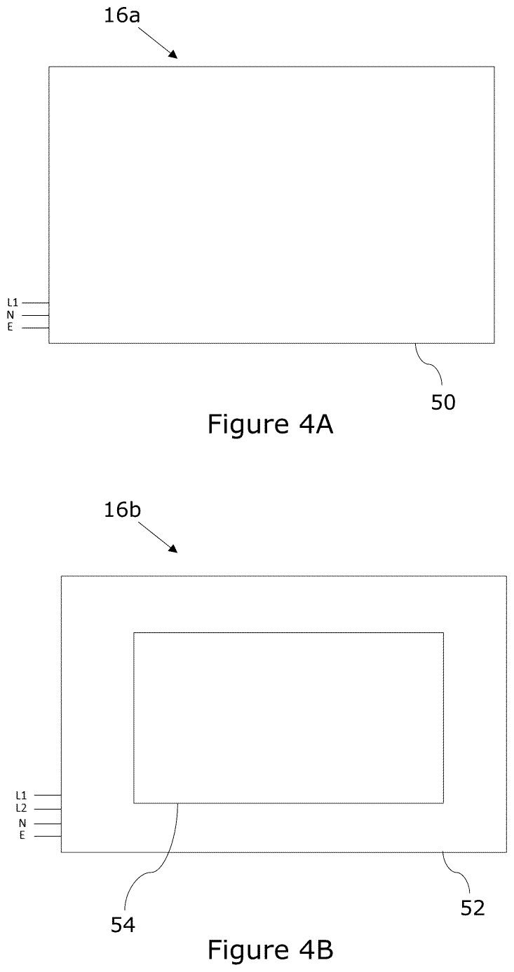

FIGS. 4A and 4B show two example infrared heating panels 16a, 16b for use in the infrared heating system 10.

FIG. 4A shows an infrared heating panel 16a with a single heating element 50. The heating panel 16a is coupled to the receiver 14 according to supplied Live, Neutral and Earth Connections (L, N, E). Therefore, the first connection 40 and live connection L provide a means to transmit signals from the controller to the infrared heating element. The single element 50 may be formed of an arrangement of wiring, such as PTC effect elements. The wiring of the single element may be arranged in any suitable arrangement which achieves a desired Watt density of 0.085-0.22 Watt/cm². For example, the wiring can be arranged in a generally sine shaped line which fills the desired surface area. The density of the wiring in areas closer to the perimeter of the infrared heater 16 can be greater than that in areas further from the perimeter. This can help to maintain temperature at the edges of the panel which may experience greater heat loss than more central areas. It is important for the element 50 to maintain a temperature high enough for infrared heat to radiate from the emission surface.

FIG. 4B shows an infrared heating panel 16b with two heating elements 52, 54. The heating panel 16b is substantially similar to the single element heating panel 16a and therefore the following description will focus on the differences. The heating panel is coupled to the receiver 14 according to supplied Neutral, Earth, and two Live Connections (L1, L2, N, E). Therefore, the first connection 40 and second connection 48 and live connections L1, L2 provide a means to transmit signals from the controller to the infrared heating elements 52, 54 independently. Therefore, the infrared heating elements 52, 54 can be independently controlled.

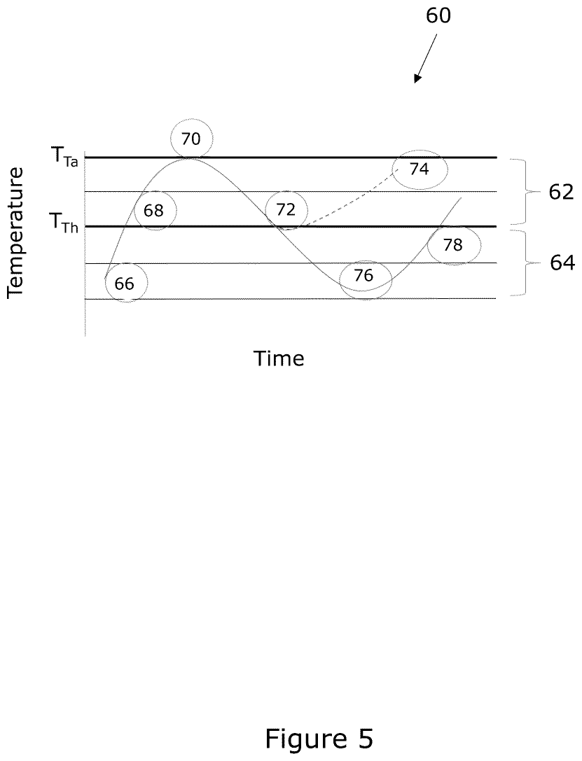

FIG. 5 shows a graphical example of a progression 60 of the infrared heater 16 operation against temperature, wherein the temperature values plotted on the graph are provided by the temperature sensor unit 12.

The target temperature T_{Ta} and threshold temperature T_{Th} are represented on the vertical axis. The target temperature T_{Ta} is the desired comfort temperature for the room. Typically, this is the air temperature setting in traditional heating systems. Most existing heating system will exceed this by 1 to 2 degrees before turning off the heater. However, this is wasteful of energy and therefore the present system utilises a novel algorithm which withdraws power to the heating elements when it has been detected that the Target temperature T_{Ta} has been reached. The threshold temperature T_{Th} is a temperature below the target temperature T_{Ta}, the difference between the threshold temperature and the target temperature can be thought of as a form hysteresis within the heating system. In some conventional heating systems, this is the temperature at which a heating system is powered down in anticipation that the target temperature has been reached but has not yet been detected due to a delay of an ambient air temperature sensor. The threshold temperature may be set 1° C. lower than the target temperature. However, this may be configurable for specialist applications.

The region 62 defines the temperature gap between the threshold temperature T_{Th} and the target temperature T_{Ta}. Within this range 62, temperature is sensed using both the air and radiant temperature sensors individually, but the system reacts to the sensor showing the greatest change. For example, temperature may be sensed using a Black Bulb thermometer or air temperature thermostat. In this region 62 the heater can be said to be in the “High Sensitivity” band. In this region 62, temperature may be “fine-tuned” by using the infrared heating panel on a lower heating setting so that the intensity of infrared radiation emitted is lower than a full power mode.

The region 64 defines the region of temperatures below the threshold temperature T_{Th}. Within this range 64, temperature is sensed using a radiant heat sensor and an ambient air temperature sensor and the average calculated between them. For example, temperature may be sensed by each type of sensor and the recorded temperatures may be averages to provide a single temperature value. Specifically, the single temperature value may be an average of air temperature and black bulb temperature. In this region 64, the heater can be said to be in the “Operative Temperature priority” band. In this region 64, the heater operates under full power and therefore temperature adjustments can be considered coarser than in region 62.

At point 66 of the operation, the current temperature is determined to be below the threshold temperature T_{Th} and therefore also below the target temperature T_{Ta}. The infrared heater is operated at full power. For example, if the infrared heater comprises multiple heating elements, all heating elements emit infrared radiation. Alternatively, if the infrared heater has a single heating element, the heating element is switched on full time and does not cycle through periods of inactivity. The current temperature of the space being temperature controlled is monitored using both radiant and air temperature sensors as the temperature is within the Operative Temperature Priority region 64.

At point 68 of the operation, the current temperature measured is determined to be equal to or above the threshold temperature T_{Th}. The temperature is then within the High Sensitivity region 62 and is thus monitored according to which sensor (air or black bulb) is moving fastest. For example, in draughtier environments, air temperature is likely to warm up less quickly, but also cool down the quickest. So the black bulb temperature may be the quickest to move in the warmup phase to build up the thermal mass but it will be the air temperature sensor that moves quickest when things cool down. Conversely, in well insulated environments the air temperature may rise more quickly than the radiant but may be the slowest also to note a decrease in temperature. The infrared heating panel will enter a different heating mode to that experienced in the Operative Temperature Priority region 62. Specifically, if the infrared heater comprises multiple heating elements, a reduced number of heating elements will emit infrared radiation in comparison to the full power mode of region 64. Alternatively, if the infrared heater has a single heating element, the heating element will cycle through periods of being on and off. This modulation may include a period of five minutes on and five minutes off. The radiant and air temperatures will continue to increase towards the target temperature however, only radiant heat is being actively monitored.

At point 70 of the operation, the radiant heat sensor detects that the space being temperature controlled has reached the target temperature T_{Ta}. At this point, power to the heating elements is switched off so that no infrared radiation is being actively emitted by the infrared heating panel. Should the radiant temperature detected reduce 72 such that the temperature is below the target temperature T_{Ta} but still within the High Sensitivity region 62, the infrared panel is powered such that infrared heat is emitted. The infrared panel may emit radiation by powering one of a plurality of heating elements or by carrying out a modulation of a single element. This will result in the measured temperature rising towards the target temperature T_{Ta}, which is shown at point 74.

If, at point 72, the space to be temperature-controlled experiences a negative temperature change, the measured temperature may drop below the threshold temperature which is shown at point 76 of the operation. The infrared heating system will then pass into the Operative Temperature Priority mode 64. This will result in the infrared heating panel being fully powered, either by a plurality of heating elements being activated or a single element being consistently powered and not modulated. This will then provide infrared radiation to the space and result in the detected temperature increasing 78.

Therefore, the controller can continue to detect coarse and fine temperature adjustments and ensure the maximum energy efficiency is being applied at all times. Due to the use of the temperature sensor unit in this way, ambient air temperature is never taken as a standalone measurement to determine which heating mode the infrared heating panel should operate in.

The operation can be represented by the following setting and algorithm in the receiver 14:

| Variables: | Meaning | Source |
|---|---|---|
| [Heater_Type] | Does the heater have multiple heating | entered by user |
| | elements (vario-power) or a single | |
| | heating element (standard)? | |
| [Setpoint] | Target Temperature | entered by user |
| [Hysteresis] | How much lag required by thermostat | entered by user |
| | (the difference between the target | (or may become a |
| | temperature and the threshold | constant) |
| | temperature) | |
| [Radiant] | Black Bulb Temperature | read by sensor |
| [Air] | Air Temperature | read by sensor |
| [Operative] | (Radiant Temp + Air Temp)/2) | calculated |
| | | by receiver |
| [T_Delta] | ([Setpoint] − [Hysteresis]) | calculated |
| | | by receiver |

### Calculation:

This is the calculation required in the receiver:

```
  If [Heater_Type]=Vario-Power
Routine Operative Priority
  WHILE [Operative] < [T_Delta]
  Relay 1 + 2 ON
Routine High Sensitivity
  WHILE [Operative] => [T_Delta]
    WHILE [Radiant] OR [Air] < [Setpoint]
      Relay 2 OFF
      Relay 1 ON
  WHILE [Radiant] AND [Air] => [Setpoint]
      Relay 1 OFF, Relay 2 OFF
OTHERWISE Routine Operative Priority
ENDIF
  If [Heater_Type]=Standard
Routine Operative Priority
  WHILE [Operative] < [T_Delta]
    Relay 1 ON
Routine High Sensitivity
  WHILE [Operative] => [T_Delta]
    WHILE [Radiant] OR [Air] < [Setpoint]
      Modulate 5 minutes ON, 5 minutes OFF
      Relay 1
  WHILE [Radiant] AND [Air] => [Setpoint]
      Relay 1 OFF
OTHERWISE Routine Operative Priority
ENDIF
```

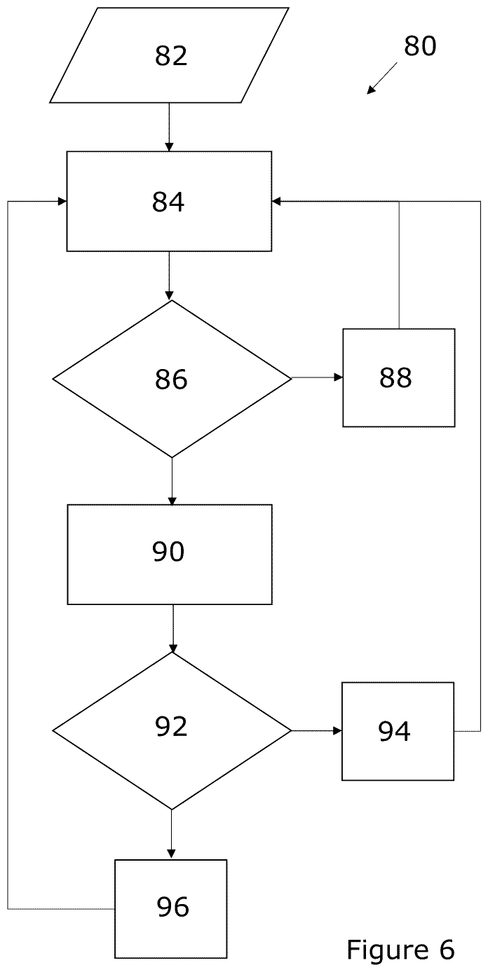

FIG. 6 shows an exemplary operation 80 of an infrared heating system 10. At step 82, a target temperature and threshold temperature are received at a controller and/or receiver. The target temperature is the desired room temperature. This temperature can be set or selected by a user. The threshold temperature is a temperature lower than the target temperature which can be selected by a user or set by the controller. For example, a user may select a room temperature of 21° C. The target temperature is then 21° C. The user or controller may then set a threshold temperature to be 1° C. less than the target temperature. The threshold temperature is then 20° C.

At step 84, a temperature measurement is taken within the space to be temperature controlled. Therefore, this temperature measurement provides the current temperature of the space. The temperature is detected using the temperature sensing unit 12 and may comprise detecting temperature using an ambient air temperature sensor and a black bulb sensor. The temperature measurement value can be determined by taking an average of the ambient air temperature and radiant heat temperature.

At step 86, the controller and/or receiver compares the temperature detected 84 to the threshold temperature. If the detected temperature is lower than the threshold temperature, the controller provides a signal to the infrared heating panel to provide and/or maintain full power 88 to the infrared heater (the infrared heater is operating in Operative Temperature Priority region 64). This provides a maximum amount of radiant heat. Whilst the infrared heater is operating at full power, the method returns to step 84 to detect the current temperature.

If, at step 86, it is determined that the detected temperature is at or above the threshold temperature, the method moves on to step 90. At step 90, a temperature measurement is taken within the space to be temperature controlled. As the temperature is above the threshold temperature, the infrared heating system is operating in the High Sensitivity mode 62 and therefore the temperature is determined at step 90 using whichever one of the air or black bulb sensors shows the greatest change.

At step 92, the controller compares the detected temperature at step 90 with the target temperature. If the detected temperature is below the target temperature, the controller provides a signal to the infrared heating panel to power and/or maintain power 94 to the infrared heating panel such that it operates in a partial heating mode. For example, if two independent heating elements are provided, at step 94, one element would be on and provide radiant heat and the other would be off and provide no radiant heat. Alternatively, if a single heating element is provided, the element may operate in modulation. Therefore, the infrared heating panel is operating in the High Sensitivity mode 62. The method then returns to step 84 and determines the current temperature.

If, at step 86 or 92, it is determined that the detected temperature is above the target temperature, the controller provides a signal to the infrared heating elements to turn off and provide no radiant heat 96. The method then returns to step 84 and determines the current temperature.

Therefore, the method 80 provides constant monitoring of the current temperature within a space which is to be temperature controlled and a means to adjust the temperature of the space.

Although the invention has been described above with reference to one or more preferred embodiments, it will be appreciated that various changes or modifications can be made without departing from the scope of the invention as defined in the appended claims. The word “comprising” can mean “including” or “consisting of” and therefore does not exclude the presence of elements or steps other than those listed in any claim or the specification as a whole. The mere fact that certain measures are recited in mutually different dependent claims does not indicate that a combination of these measures cannot be used to advantage.

What is claimed is:

1. An infrared heating system comprising:
an infrared heater;
a temperature sensor unit comprising a radiant heat sensor and an air temperature sensor;
a controller arranged to:
receive a target temperature;
receive temperature sensor data from the temperature sensor unit; and
provide an output signal to the heater based on the temperature sensor data and the target temperature.

2. The system according to claim 1, wherein the infrared heater is configured to operate in at least two heating modes, wherein the first heating mode is a full power mode and the second heating mode is a partial heating mode such that the infrared output over a time period is lower in the second heating mode than the first heating mode.

3. The system according to claim 2, wherein, when operating in the first heating mode, the temperature sensor data comprises data based on an average of the temperature sensor data from the radiant heat sensor and the air temperature sensor and, when operating in the second heating mode the temperature sensor data consists of data from whichever of the radiant heat sensor and the air temperature sensor that detects temperature change the fastest.

4. The system according to claim 2, wherein the controller is configured to switch the heater between the first and second heating modes based on a comparison between the operative temperature sensor data and a threshold temperature.

5. The system according to claim 4, wherein, when operating in the second heating mode, the temperature sensor data consists of data from whichever of the radiant heat sensor and the air temperature sensor that detects a change in temperature the fastest wherein the controller is arranged to periodically reassess which of the radiant heat sensor and the air temperature sensor detects a change in temperature the fastest.

6. The system according to claim 1, further comprising a user input module configured to enable a user to provide the target temperature and/or select a heating mode.

7. The system according to claim 6, wherein the controller comprises the user input module or is arranged to wirelessly communicate with the user input module.

8. The system according to claim 1, wherein the radiant heat sensor comprises a black bulb thermostat.

9. The system according to claim 1, wherein the infrared heater demonstrates a surface temperature rise of at least 75° C.

10. The system according to claim 1, wherein the infrared heater and the temperature sensor unit are arranged to be co-located in an enclosed space.

11. An enclosed space comprising the system according to claim 1, wherein the temperature sensor unit is configured to maintain a direct line of sight to the infrared heater.

12. A method for controlling an infrared heater comprising:
receiving a target temperature;
receiving a threshold temperature;
detecting a temperature;
operating the infrared heater in a first heating mode when the detected temperature is lower than the threshold temperature and lower than the target temperature; and
operating the infrared heater in a second heating mode when the detected temperature is lower than the target temperature and greater than the threshold temperature,
wherein detecting the temperature comprises receiving temperature sensor data from a radiant heat sensor and an air temperature sensor.

13. The method according to claim 12, wherein the first heating mode is a full power mode and the second heating mode is a partial heating mode such that the infrared emission over a time period is lower in the second heating mode than the first heating mode.

14. The method according to claim 12, wherein detecting the temperature during the first heating mode comprises averaging a temperature measurement taken by the radiant heat sensor and a temperature measurement taken by the air temperature sensor, and wherein detecting a temperature during the second heating mode consists of detecting a temperature value using whichever one of the radiant heat sensor and air temperature sensor reacts quickest.

15. The method according to claim 12, wherein the target temperature and/or the threshold temperature is input via a user device wirelessly connected to the infrared heater.
